(19) United States
(12) Patent Application Publication
(10) Pub. No.: US 2015/0308473 A1
(43) Pub. Date: Oct. 29, 2015

(54) FASTENING MEANS AND ATTACHMENT ASSEMBLY

(71) Applicant: SAAB AB, Linköping (SE)

(72) Inventors: Kjell STENBOM, Norrköping (SE); Magnus Bergelin, Linköping (SE)

(21) Appl. No.: 14/442,870

(22) PCT Filed: Nov. 14, 2012
(86) PCT No.: PCT/SE2012/051255

§ 371 Date: May 14, 2015

(51) Int. Cl. F16B 5/02

(52) U.S. Cl. CPC F16B 5/02

(57) ABSTRACT

A fastener and an attachment assembly. The fastener includes a bolt having a first bolt portion, a second bolt portion and an intermediate bolt portion arranged between the first bolt portion and the second bolt portion. The first bolt portion is conical and the second bolt portion is threaded. A first bushing has a conical inner surface arranged in circumferential abutment to the first bolt portion and a nut to be threadedly engaged to the second bolt portion. The attachment assembly secures objects to each other and includes at least two bores, arranged through the objects, including a first bore portion, a second bore portion and an intermediate bore portion, respectively. The intermediate bore portion is arranged between the first bore portion and the second bore portion. The attachment assembly also comprises at least two fasteners, each fastener is arranged inside the bores, respectively.

### TECHNICAL FIELD

The present invention relates to a fastening means according to the preamble of claim 1. The invention also relates to an attachment assembly.

### TECHNICAL BACKGROUND

Fastening means of the type that mechanically joins and affixes two or more objects together are used in a wide range of applications, for example automobiles and aerial vehicles. Fastening means on the market today, for example core bolts inserted in clamping sleeves, comprise many parts and these parts often do not comprise smooth surfaces. Attachment assemblies comprise two or more objects mechanically joined and affixed together by such fastening means and are used in a wide range of applications, for example automobiles and aerial vehicles. Attachment assemblies on the market today, each for example comprising a rotor hub, rotor blades and fastening means, comprise many parts and these parts often do not comprise smooth surfaces.

Because the parts comprised in the fastening means and in the attachment assemblies do not comprise smooth surfaces a large portion of their surfaces are not in abutment to each other. It is therefore easy for unwanted particles to enter between the parts. This result in that it is difficult and time consuming to keep the fastening means and the attachment assemblies clean from unwanted particles such as dust, grit and contaminants. This results in turn to more expensive maintenance of the fastening means and the attachment assemblies. If the fastening means or the attachment assemblies are arranged in an aerial vehicle, for example a helicopter, it is a disadvantage that it is time consuming to keep the fastening means and the attachment assemblies clean because it leads to that the time for service of the aerial vehicle increases and in turn the aerial vehicles availability decreases. In worst case the fastening means or the attachment assemblies can, if the unwanted particles are not removed from the fastening means or the attachment assemblies, get damaged or broken. If the fastening means or the attachment assemblies are arranged in an aerial vehicle it is a disadvantage if the fastening means or the attachment assemblies get damaged or broken because it leads to decreasing operational safety of the aerial vehicle.

If a rotor blade of an aerial vehicle is changed during maintenance of the aerial vehicle and unwanted particles enter between the fastening means and the bores passing through the rotor blade and wherein the fastening means is inserted, the bores of the rotor blade can get damaged. If the bores of a rotor blade get damaged it can lead to that the rotor blade has to be discarded, which also leads to a more time consuming and more expensive maintenance of the aerial vehicle.

As described earlier, attachment assemblies comprise objects being joined and affixed to each other and often a bolt inserted in bores passing through these objects. It will be impossible to mount the bolt in the bores if the bores through the different objects, for example through a rotor blade and through a rotor hub, are not aligned. One solution could be to increase the diameter of the bores or decrease the core diameter of the bolt to fit some existing expandable fastener or similar, but that would be a disadvantage because it will result in a weaker construction with greater play between the attachment assembly's components. To ensure that the bores are made to the correct specifications and therefore are aligned they need to be co-bored or a master fixture needs to be used. A master fixture is however expensive to manufacture because it is built to fit a particular object. Co-boring of holes leads to a more time consuming and a more expensive production.

A rotor system substantially comprises a rotor hub connected to a rotor drive shaft, and a number of rotor blades fixed to and projecting radially from the rotor hub. Each rotor blade is fitted in one end with a fastening means for connection to a respective arm of the hub. More specifically, the end of the hubs arm is typically C-shaped with opposite parallel end portions connected releasable to one end of the respective rotor blade. Rotor systems are classified according to how the rotor blades are attached and move relative to the rotor hub. There are three basic classifications: rigid, semi rigid or fully articulated rotor systems. In a fully articulated rotor system, each rotor blade is attached to the rotor hub through a series of hinges which allow the blade to move independently of the others. Dampers are usually used in articulated rotor systems to prevent excess back and forth movement. Rigid and semi rigid rotor systems do not permit the rotor blades to move, relative to the rotor hub, back and forth slightly in the horizontal plane because the back-and-forth hunting can develop into serious unwanted vibrations. The terms “dragging,” “hunting,” and “lead-lag” are also used to describe this movement. The vibrations can result in component wear, for example bending or even breaking of the rotor blades, which in turn can result in an aerial vehicle crash. To decrease the movement back and forth in the horizontal plane the play in the attachment between the rotor blades and the rotor hub is limited by using components with tight tolerances. It is however expensive to manufacture components with tight tolerances because machining and inspection of the components are time consuming and the component rejection rate increases. Even if the components have tight tolerances it is difficult to achieve an attachment between the rotor blades and the rotor hub with limited play because the several tolerances need to cooperate with each other.

Another example of a known fastening means and attachment assembly are disclosed in document U.S. Pat. No. A1-4,961,687. U.S. Pat. No. A1-4,961,687 discloses a fastening device including sleeves for absorbing forces, and a rotor blade equipped with such a device for fastening to a hub. The device comprises an inner metallic sleeve having a cylindrical central bore and having a frusto-conical outer lateral face which is pressed coaxially and is affixed in the frusto-conical inner bore of an outer sleeve provided with a slot along one of its generatrices, and fitted into a recess delimited in the blade root by a loop formed of bands of rovings of the spar of the blade. The fitting of the two sleeves into one another involves a deformation by radial expansion of the outer sleeve, which adapts itself to the diameter of the recess provided in the composite materials of the blade root. The invention applies to helicopter rotor blades.

The fastening means and attachment assembly that are disclosed in the document U.S. Pat. No. A1-4,961,687 has a drawback. The conical sleeves in document U.S. Pat. No. A1-4,961,687 surround both the part of the bolt which abuts the rotor hub and the part of the bolt which abuts the rotor blade. This results in that the hole in the rotor blade must be larger or that the diameter of the bolt must be smaller, which leads to a too weaker construction.

As a consequence, in light of the above drawbacks, there is a need of a fastening means and an attachment means which are less time consuming and less expensive to produce, easier to maintain, and an attachment means with a strong construction which avoid lateral vibrations.

### SUMMARY OF THE INVENTION

The subject of the present invention is to eliminate the drawbacks according to prior art.

This subject has been by fulfilled with the fastening means as well as the attachment assembly according to the claims. More specifically the fastening means comprises a bolt having a first bolt portion, a second bolt portion and an intermediate bolt portion arranged between the first bolt portion and the second bolt portion. The first bolt portion is conical and the second bolt portion is threaded. The fastening means further comprises a first bushing with a conical inner surface arranged in circumferential abutment to the first bolt portion and a nut to be threadedly engaged to the second bolt portion.

In another aspect of the invention the first bushing has a cylindrical outer surface. In a further aspect of the invention the fastening means comprises an intermediate bushing arranged in circumferential abutment to the intermediate bolt portion. In yet another aspect of the invention the intermediate bolt portion is cylindrical and the intermediate bushing has a cylindrical inner surface. In another aspect of the invention the intermediate bushing has a cylindrical outer surface. In a further aspect of the invention the fastening means comprises a sleeve arranged in circumferential abutment to the second bolt portion. Further, the second bolt portion can be cylindrical and the sleeve may have a cylindrical inner surface. In another aspect of the invention the fastening means comprises a second bushing arranged in circumferential abutment to the sleeve. In addition the sleeve can have a conical outer surface and the second bushing can have a conical inner surface. In yet another aspect of the invention the second bushing has a cylindrical outer surface. In another aspect of the invention the second bolt portion is provided with a locking element.

The attachment assembly for securing objects to each other comprises at least two bores, arranged through the objects, comprising a first bore portion, a second bore portion and an intermediate bore portion, respectively. The intermediate bore portion is arranged between the first bore portion and the second bore portion. The attachment assembly also comprises at least two fastening means of the kind described above according to the invention, each arranged inside the bores, respectively.

In another aspect of the invention the objects to be secured comprise a rotor hub having a first protruding arm, a second protruding arm and a recess between the arms. A rotor blade is arranged in the recess. The first bore portion is extending through the first protruding arm, the intermediate bore portion is extending through the rotor blade and the second bore portion is extending through the second protruding arm.

The fastening means and the attachment assembly according to the present invention comprises few parts compared to prior art and all these parts have smooth surfaces in abutment to each other. It is therefore difficult for unwanted particles, such as dust, grit and contaminants, to enter between the parts. This results in turn to less time consuming and less expensive maintenance of the fastening means and attachment assembly. If the fastening means or attachment assembly is arranged in an aerial vehicle, for example a helicopter, a less time consuming maintenance is an advantage because it leads to that the time for service of the aerial vehicle decreases and in turn the aerial vehicles availability increases. If the fastening means or attachment assembly is arranged in an aerial vehicle it is also an advantage that the risk of the fastening means or attachment assembly getting damaged or broken decrease because it leads to increasing operational safety of the aerial vehicle.

Because the attachment assembly according to the present invention comprises few parts with smooth surfaces in abutment to each other the play between the parts is limited. This results in decreasing vibrations and in turn decreasing component wear. If the attachment assembly is arranged in an aerial vehicle with a rigid or semi rigid rotor system the movement in the horizontal plane is decreased and in turn the risk of an aerial vehicle crash is decreased.

The fastening means and the attachment assembly according to the present invention comprise a bolt with a conical head and a conical bushing in circumferential abutment to the conical head. Because the head is conical it is self centred when inserted into the conical bushing. Therefore the fastening means and the attachment assembly are easier to assemble, disassemble and reassemble compared to fastening means and attachment assemblies comprising a bolt with a cylindrical head and a cylindrical bushing in circumferential abutment to the cylindrical head. Because the fastening means and the attachment assembly are easier to assemble the parts comprised in the fastening means and the attachment assembly can have less tight tolerances. Therefore the use of a master fixture or co-boring of the bores comprised in the attachment assembly is not needed. This results in a less time consuming and less expensive production.

As described above, the conical sleeve in the attachment assembly only surrounds the head of the bolt. The remainder of the bolt and the bushings in circumferential abutment to the remainder of the bolt are cylindrical. This results in that the bores in which the bushings in circumferential abutment to the remainder of the bolt are inserted do not have to be larger or that the diameter of the bolt does not have to be smaller, which leads to a stronger construction.

Other objectives, embodiments and advantages of the present invention are described in closer detail in the description and in the subsequent patent claims.

### BRIEF DESCRIPTION OF THE DRAWINGS

In the following prior art and the invention will be described with reference to embodiments of prior art, embodiments of the present invention and the accompanying drawings, in which:

FIG. 1A shows a perspective view of two fastening means, wherein one fastening means is exploded, according to prior art,

FIG. 1B shows a perspective view of an attachment assembly, wherein one fastening means is exploded, according to prior art,

FIG. 2 shows a cross sectional view of a fastening means according to the present invention, and

FIG. 3 shows a cross sectional view of an attachment assembly according to the present invention.

### DETAILED DESCRIPTION OF PRIOR ART AND THE INVENTION

In the following a number of embodiments of prior art and the invention are shown and described. The same reference numbers have been used for the same or similar features throughout the description in the embodiments disclosed below.

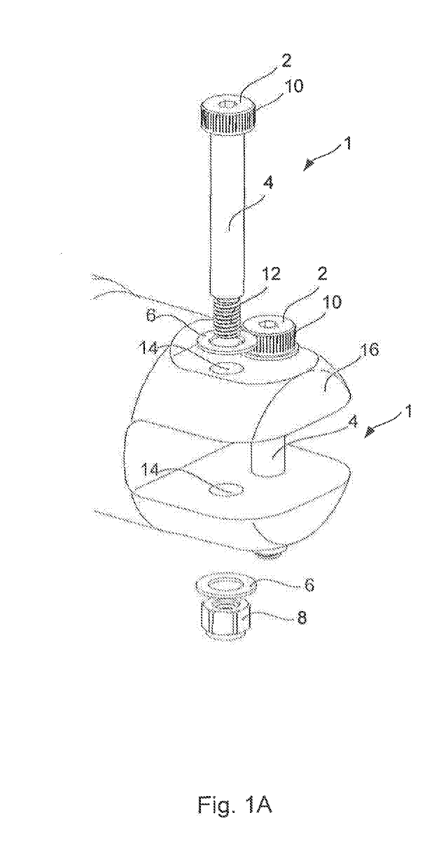

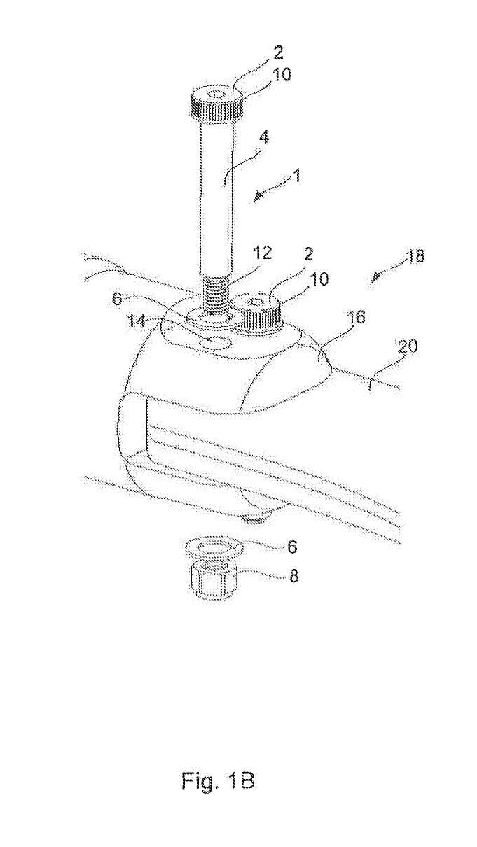

FIG. 1A shows a perspective view of two fastening means 1, wherein one fastening means 1 is exploded, according to prior art. The respective fastening means 1 comprise a cylindrical bolt 2, for example a fitting bolt, a cylindrical bushing 4, arranged in circumferential abutment to the cylindrical bolt 2, two washers 6, arranged in circumferential abutment to the cylindrical bushing 4 and a nut 8. The respective cylindrical bolt 2 comprise a head 10 and a threaded portion 12, with threads along the threaded portions 12 length, arranged opposed to the head 10. The respective nut 8, having internal threads matching the threads of the threaded portion 12, is arranged on the threaded portion 12 to fasten the cylindrical bolt 2, the cylindrical bushing 4 and the washers 6 together. The respective fastening means 1 is arranged inside two bores 14 passing through a first object 16, for example a rotor hub. By tightening the nut 8 the fastening means 1 can be assembled disassembled and reassembled.

FIG. 1B shows a perspective view of an attachment assembly 18, wherein one fastening means 1 is exploded, according to prior art. The respective fastening means 1 comprise the same features as shown in FIG. 1A and that are described above. These features have the same reference numbers as in FIG. 1A. The respective fastening means 1 is also arranged inside two bores 14 passing through a second object 20, for example a rotor blade. The respective nut 8 fastens the cylindrical bolt 2, the cylindrical bushing 4, the washers 6, the first object 16 and the second object 20 together. By tightening the nut 8 the attachment assembly 18 can be readily assembled, disassembled and reassembled.

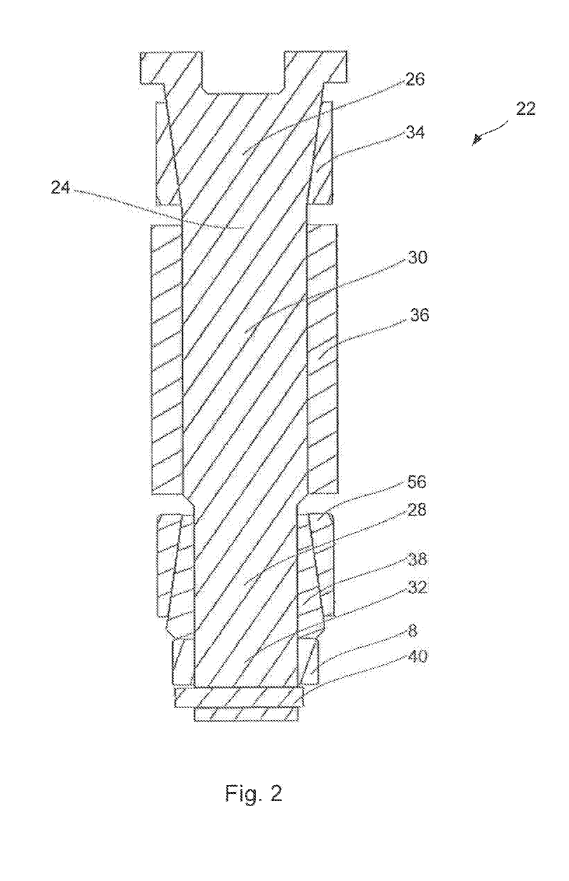

FIG. 2 shows a cross sectional view of a fastening means 22 according to the present invention. The fastening means comprises a bolt 24. The bolt 24 comprises a first bolt portion 26, a second bolt portion 28 and an intermediate bolt portion 30. The first bolt portion 26, also called head, is arranged opposed to the second bolt portion 28. The intermediate bolt portion 30 is arranged between the first bolt portion 26 and the second bolt portion 28. The first bolt portion 26 is constituted by a head in the form of a frustum of a cone with a top and a base, wherein the top is arranged opposed to the base and wherein the base is arranged in the end of the bolt 24. The second bolt portion 28 and the intermediate portion 30 are cylindrical. The second bolt portion 28 comprises a threaded portion 32, with threads along the threaded portions 32 length, arranged in the end of the bolt 24.

A first bushing 34 is arranged in circumferential abutment to the first bolt portion 26. The first bushing 34 comprises a cylindrical outer surface and a conical inner surface, wherein the conical inner surface is in the form of a frustum of a cone with a top and a base, wherein the top is arranged opposed to the base and the base is arranged in circumferential abutment to the base of the first bolt portion 26. An intermediate bushing 36, comprising a cylindrical inner and outer surface, is arranged in circumferential abutment to the intermediate bolt portion 30. A sleeve 38 is arranged in circumferential abutment to the second bolt portion 28 and inside a second bushing 56. The sleeve 38 comprises a cylindrical inner surface and a conical outer surface, wherein the conical outer surface is in the form of a frustum of a cone with a top and a base, wherein the top is arranged opposed to the base and the base is arranged in circumferential abutment to the end of the bolt 24. The second bushing 56 comprises a cylindrical outer surface and a conical inner surface, wherein the conical inner surface is in the form of a frustum of a cone with a top and a base, wherein the top is arranged opposed to the base and the base is arranged in circumferential abutment to the base of the sleeves 38 outer surface.

A nut 8, having internal threads matching the threads of the threaded portion 32, is arranged on the threaded portion 32 to fasten the bolt 24, the first bushing 34, the intermediate bushing 36 and the sleeve 38 together. By tightening the nut 8 the fastening means 22 can readily be assembled, disassembled and reassembled. The nut 8 can be constituted by a wide range of different types of nuts, for example a castle nut or a locking nut. A locking element 40 is arranged through the second threaded bolt portion 32, at the end of the bolt 24. It is advantageous that the fastening means 22 comprise the locking element 40 when the fastening means 22 is used in applications where vibration or rotation can make the nut 8 disappear. It is possible to use various locking elements 40, for example a cotter pin.

The bolt 24, the first bushing 34, the intermediate bushing 36, the sleeve 38, the locking element 40 and the nut 8 can be made of many different types of materials and they can have different lengths, thicknesses and finishes. The fastening means 22 according to the present invention can be used in a wide range of applications, for example automobiles and aerial vehicles.

The parts comprised in the fastening means 22 all have smooth surfaces in abutment to each other. The first bushing 34 is in substantial abutment with the first bolt portion 26 along the whole abutment surface between the first bushing 34 and the first bolt portion 26. The intermediate bushing 36 is in substantial abutment with the intermediate bolt portion 30 along the whole abutment surface between the intermediate bushing 36 and the intermediate bolt portion 30. The sleeve 38 is in substantial abutment with the second bolt portion 28 along the whole abutment surface between the sleeve 38 and the second bolt portion 28. The second bushing 56 is in substantial abutment with the sleeve 38 along the whole abutment surface between the second bushing 56 and the sleeve 38.

It is therefore difficult for unwanted particles to enter between the parts. This results in that the time for keeping the fastening means 22 clean from unwanted particles, such as dust, grit and contaminants, decreases. In turn it results to less expensive and less time consuming maintenance of the fastening means 22. If the fastening means 22 are arranged in an aerial vehicle, for example a helicopter, it is an advantage with less time consuming maintenance of the fastening means 22 because it leads to that the time for service of the aerial vehicle decreases and in turn the aerial vehicles availability increases. If the fastening means 22 are arranged in an aerial vehicle it is an advantage that the fastening means 22 do not get damaged or broken due to unwanted particles entering between the different parts because it leads to increasing operational safety of the aerial vehicle.

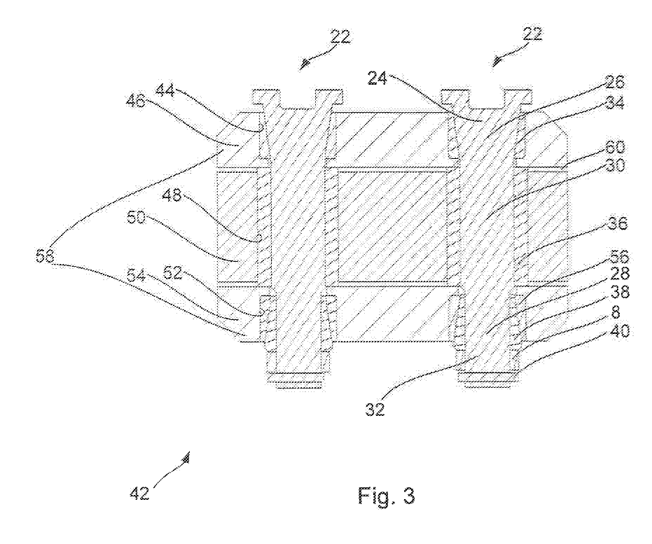

FIG. 3 shows a cross sectional view of an attachment assembly 42 according to the present invention. The attachment assembly 42, such as for example a rotor blade and hub attachment assembly, comprises a fastening means 22, a first object 46, an intermediate object 50 and a second object 54. The respective fastening means 1 comprise the same features as shown in FIG. 2 and that are described above. These features have the same reference numbers as in FIG. 2. A rotor system substantially comprises a rotor hub 58 connected angularly to a rotor drive shaft, and a number of rotor blades 50 fixed to and projecting radially from the rotor hub 58. Each rotor blade 50 is fitted in one end with a fastening means 22 for connection to a respective arm of the rotor hub 58. More specifically, the rotor hub 58 is typically C-shaped with a first protruding arm 46 and a second protruding arm 54, a recess 60 between the arms 46 and 54 and a rotor blade 50 arranged in the recess 60. The first protruding arm 46 and the second protruding arm 54 are parallel to each other. The rotor hub 58 is joined and affixed to at least two rotor blades 50, preferably in a rigid or semi rigid rotor system.

A first bushing 34 is arranged in circumferential abutment to the first bolt portion 26 and inside a first bore 44 passing through a first object 46, for example a rotor hub 58. The first bushing 34 can be arranged inside the first bore 44 by pressing the first bushing 34 into the first bore 44. The first bushing 34 comprises a cylindrical outer surface and a conical inner surface, wherein the conical inner surface is in the form of a frustum of a cone with a top and a base, wherein the top is arranged opposed to the base and the base is arranged in circumferential abutment to the base of the first bolt portion 26. An intermediate bushing 36, comprising a cylindrical inner and outer surface, is arranged in circumferential abutment to the intermediate bolt portion 30 and inside an intermediate bore 48 passing through an intermediate object 50, for example a rotor blade 50. An advantageous positional tolerance for the intermediate bushing 36 and the bolt 24 can be H5 or G5. The intermediate bushing 36 can be integrated to the inside of the intermediate bore 48, by for example moulding. A sleeve 38 is arranged in circumferential abutment to the second bolt portion 28 and inside a second bushing 56. The sleeve 38 comprises a cylindrical inner surface and a conical outer surface, wherein the conical outer surface is in the form of a frustum of a cone with a top and a base, wherein the top is arranged opposed to the base and the base is arranged in circumferential abutment to the end of the bolt 24. The second bushing 56 comprises a cylindrical outer surface and a conical inner surface, wherein the conical inner surface is in the form of a frustum of a cone with a top and a base, wherein the top is arranged opposed to the base and the base is arranged in circumferential abutment to the base of the sleeves 38 outer surface. The second bushing 56 is arranged inside a second bore 52 passing through a second object 54.

The first bore 44, the intermediate bore 48 and the second bore 52 does not need to be totally concentric depending on the outcome of the tolerances. The pitch between the first bore 44 and the intermediate bore 48, the pitch between the intermediate bore 48 and the second bore 52 and the pitch between the first bore 44 and the second bore 52 can be for example 0.1 mm. Because the first bore 44, the intermediate bore 48 and the second bore 52 does not need to be totally concentric they do not need to be co-bored and a master fixture is not needed. This leads to a less expensive and less time consuming production of the attachment assembly 42. The first bore 44, the intermediate bore 48 and the second bore 52 can suitably have a diameter of about 6-50 mm.

A nut 8, having internal threads matching the threads of the threaded portion 32, is arranged on the threaded portion 32 to fasten the bolt 24, the first bushing 34, the intermediate bushing 36, the sleeve 38, the second bushing 56, the first object 46, the intermediate object 50 and the second object 54 together. Because the first bolt portion 26 has a conical outer surface it is self centered when it is inserted into the first bushing 34 with a conical inner surface. By tightening the nut 8 the fastening means 22 can therefore readily be assembled, disassembled and reassembled. The nut 8 can be constituted by a wide range of different types of nuts, for example a castle nut or a locking nut.

A locking element 40 is arranged through respective threaded bolt portion 32, at the end of the bolt 24. The locking element 40 is not required, but it is advantageous that the attachment assembly 42 comprise the locking element 40 when the attachment assembly 42 is used in applications where vibration or rotation can make the nut 8 disappear from the threaded bolt portion 32. It is possible to use various locking elements, for example a cotter pin.

The bolt 24, the first bushing 34, the intermediate bushing 36, the sleeve 38, the second bushing 56, the locking element 40 and the nut 8 can be made of many different types of materials and they can have different lengths, thicknesses and finishes. The attachment assembly 42 is not limited to comprise three objects (in this embodiment a first object 46, an intermediate object 50 and a second object 54); it can comprise a large plurality of objects.

As described above, all the parts comprised in the fastening means 22 have smooth surfaces in abutment to each other. Also the first bushing 34 is in substantial abutment with the first bore portion 44 along the whole abutment surface between the first bushing 34 and the first bore portion 44, the intermediate bushing 36 is in substantial abutment with the intermediate bore portion 48 along the whole abutment surface between the intermediate bushing 36 and the intermediate bore portion 48 and the second bushing 56 is in substantial abutment with the second bore portion 52 along the whole abutment surface between the second bushing 56 and the second bore portion 52. The attachment assembly 42 therefore has the same advantages as the fastening means 22 described above. Yet another advantage is that the discard of parts comprised in the attachment assembly 42, for example rotor blades 50, decreases.

The invention is not limited by what has been particularly shown or described, except as indicated by the appended claims.

1. A fastening means (22), comprising a bolt (24) having a first bolt portion (26), a second bolt portion (28) and an intermediate bolt portion (30) arranged between the first bolt portion (26) and the second bolt portion (28), where the first bolt portion (26) is conical and the second bolt portion (28) is threaded, further comprising a first bushing (34) arranged in circumferential abutment to the first bolt portion (26), and a nut (8) to be threadedly engaged to the second bolt portion (28),
characterized in that
the first bushing (34) has a conical inner surface.

2. The fastening means according to claim 1, wherein the first bushing (34) has a cylindrical outer surface.

3. The fastening means according to claim 1 or 2, comprising an intermediate bushing (36) arranged in circumferential abutment to the intermediate bolt portion (30).

4. The fastening means according to claim 3, wherein the intermediate bolt portion (30) is cylindrical and wherein the intermediate bushing (36) has a cylindrical inner surface.

5. The fastening means according to claim 3 or 4, wherein the intermediate bushing (36) has a cylindrical outer surface.

6. The fastening means according to any of the previous claims, comprising a sleeve (38) arranged in circumferential abutment to the second bolt portion (28).

7. The fastening means according to claim 6, wherein the second bolt portion (28) is cylindrical and the sleeve (38) has a cylindrical inner surface.

8. The fastening means according to claim 6 or 7, comprising a second bushing (56) arranged in circumferential abutment to the sleeve (38).

9. The fastening means according to claim 8, wherein the sleeve (38) has a conical outer surface and the second bushing (56) has a conical inner surface.

10. The fastening means according to claim 8 or 9, wherein the second bushing (56) has a cylindrical outer surface.

11. The fastening means according to any of the previous claims, wherein the second bolt portion (28) is provided with a locking element (40).

12. An attachment assembly (42) for securing objects (46, 50, 54) to each other, comprising at least two bores, arranged through the objects (46, 50, 54), each bore comprising a first bore portion (44), a second bore portion (52) and an intermediate bore portion (48), respectively, the intermediate bore portion (48) is arranged between the first bore portion (44) and the second bore portion (52), and at least two fastening means (22) according to one or more of claims 1-11, each of the fastening means (22) being arranged inside the bores (44, 48, 52), respectively.

13. The attachment assembly (42) according to claim 12, wherein the objects (46, 50, 54) to be secured comprises a rotor hub (58) having a first protruding arm (46) and a second protruding arm (54), a recess (60) between the arms (46, 54) and a rotor blade (50) arranged in the recess (60), the first bore portion (44) is extending through the first protruding arm (46), the intermediate bore portion (48) is extending through the rotor blade (50) and the second bore portion (52) is extending through the second protruding arm (54).
